(19) United States
(12) Patent Application Publication
(10) Pub. No.: US 2012/0025471 A1
(43) Pub. Date: Feb. 2, 2012

(54) SELF ADJUSTING GASKET FOR PIPE JOINTS

(75) Inventors: William C. Andrick, North Canton, OH (US); Ronald M. Mayfield, Atwater, OH (US); James A. Westhoff, Langhome, PA (US)

(73) Assignee: Vertex, Inc.

(21) Appl. No.: 13/267,016

(22) Filed: Oct. 6, 2011

Related U.S. Application Data
(63) Continuation-in-part of application No. 12/637,433, filed on Dec. 14, 2009.
(60) Provisional application No. 61/122,976, filed on Dec. 16, 2008.

(51) Int. Cl. F16L 21/035; F16L 21/04

(52) U.S. Cl. 277/314; 277/605; 156/306.6

(57) ABSTRACT

The present disclosure pertains to a self adjusting gasket to prevent leakage at a joint between an associated first pipe and an associated second pipe including a wedge shaped body made of a generally compressible, leak proof material. The wedge shaped body having a profile that includes a tapered front portion, a planar rear portion, a first contact surface, an inclined second contact surface, including a first fin having a trailing edge oriented generally normal to the first contact surface and a second fin spaced from the first fin. A generally continuous annular cavity is located in the wedge shaped body wherein the cavity is not symmetrically shaped and a fluid disposed in the cavity.

This application is a Continuation-In-Part of U.S. patent application Ser. No. 12/637,433 which was filed on Dec. 14, 2009 and is still pending. That application claims priority from U.S. Provisional Application Ser. No. 61/122.976 which was filed on Dec. 16, 2008. Both applications are incorporated by reference hereinto in their entireties.test

### BACKGROUND

The present exemplary embodiment relates to a self adjusting gasket for pipe joints. It finds particular application in conjunction with pipe joints having an interface with a non-circular perimeter, and will be described with particular reference thereto. However, it is to be appreciated that the gasket is usable with generally circular pipe joints as well as other like applications.

Pipe systems are utilized to transfer fluids from one location to another. There are many types of pipe systems including, for example, sanitary, domestic water, steam, air, fuel/oil and storm drainage systems. Pipe systems include a series of elongated hollow pipe sections having many different sizes and cross sectional shapes such as rectangular, square, oval and circular. Generally, the pipe sections are manufactured in a factory, transported to a fluid transfer site and installed on site at the location where the fluid is to be transferred. Materials commonly used to manufacture pipe sections include concrete, metal, stone, polyvinyl chloride (PVC) and other thermoplastic polymers. Additionally, many pipe systems are installed underground and subject to both external forces from the environment and internal forces from the fluid being transferred.

Many pipe systems utilize gaskets between the joints of each pipe section to help prevent the leakage of fluid. The joints exist at an interface between a first pipe section and a second pipe section. In bell and spigot piping systems, the gasket is placed at the interface to abut both a spigot end of a first pipe section and a bell end of a second pipe section, the spigot end being received within the bell end. Gaskets are made of a flexible waterproof material and meant to prevent fluid from leaking at the joint while they are subject to various external forces and internal forces that act on the pipe system. The sealing effect of the gasket may be compromised due to the various forces acting thereon and misalignment of the pipe sections or inconsistent gaps between the surfaces along the interface.

To improve the alignment and sealing effect of the interface, one manufacturer provides gaskets including a profile having at least one projection extending from the body of the gasket to compressively abut a surface on the spigot end and a surface on the bell end. Another manufacturer provides gaskets including a profile having a generally hollow tube protruding from the gasket body with a layer of locking teeth and lubricant along the inner surface of the tube to aid in the self alignment of the gasket in the joint. Additionally, self aligning gaskets are known to include an internal cavity within the gasket body to hold a fluid and provide a dynamic seal at circular interfaces. There are many other types of gasket systems having similar features.

However, these known gaskets do not conform to the perimeter sections of pipe ends that transition between radial or angular portions along the joints due to stresses that are, in part, caused by the transition in joint geometry. Known gaskets fail to provide a consistent seal at the interface between the surfaces of the bell and spigot, especially along a transitioning joint geometry such as between lateral portions and corner or angled portions of the joint, such as rectangular or square joints.

Therefore, there remains a need for a self aligning gasket for improved sealing of pipe systems utilizing a bell and spigot type joint which better conforms to transitioning radial and linear portions of the joint geometry.

### BRIEF DESCRIPTION

In one embodiment, the present disclosure pertains to a self adjusting gasket which retards leakage at a joint between an associated first pipe and an associated second pipe including a wedge shaped body made of a generally compressible, leak proof material. The wedge shaped body has a profile that includes a tapered front portion, a planar rear portion, a first contact surface, and an inclined second contact surface, including a first fin having a trailing edge oriented generally normal to the first contact surface and a second fin spaced from the first fin. A generally continuous annular cavity is located in the wedge shaped body wherein the cavity is not symmetrically shaped and a fluid disposed in the cavity.

In another embodiment of the present disclosure, provided is a method of retarding leakage at an interface of a spigot end of a first pipe and a bell end of a second pipe. The method includes mounting a self adjustable gasket to the spigot end of the first pipe, the gasket having a wedge shaped profile with a continuous annular cavity having a generally asymmetrical profile relative to the interface, the cavity holding a fluid. The bell end of the second pipe is positioned on the spigot end of the first pipe along the interface. The gasket is compressed against the bell end of the second pipe. The fluid is distributed within the annular cavity to balance a compressive force along the interface such that a continuous seal is established along the interface.

In still another embodiment of the present disclosure, a self adjusting gasket including a compressible wedge shaped body is provided. The wedge shaped body includes a contact surface having a plurality of compression ribs, an inclined surface extends from the contact surface at a tapered front portion, the inclined surface including at least one resilient sealing member extending away from the inclined surface. An abutment surface is located opposite the tapered front portion, said abutment surface being oriented generally normal to the contact surface. An annular cavity is located within the gasket that encloses an amount of fluid, the annular cavity having an orientation that is generally asymmetrical relative to the contact surface.

### BRIEF DESCRIPTION OF THE DRAWINGS

The present disclosure may take form in certain parts and arrangements of parts, several embodiments of which will be described in detail in the specification and illustrated in the accompanying drawings which form a part hereof and wherein:

FIG. 1 is a cross sectional view of a partial pipe section illustrating a first embodiment of a self adjusting gasket mounted on a spigot end of a first pipe and spaced from a bell end of a second pipe during assembly according to the present disclosure;

FIG. 2 is a cross sectional view of the pipe joint of FIG. 1 in an assembled condition with the self adjusting gasket compressed along an interface formed between the spigot end of the first pipe and the bell end of the second pipe;

FIG. 3A is a cross sectional view of a partial pipe section illustrating a second embodiment of the self adjusting gasket mounted on the spigot end of the first pipe according to the present disclosure;

FIG. 3B is a cross sectional view of the self adjusting gasket of FIG. 3A compressed along the interface between the spigot end of the first pipe and a bell end of the second pipe;

FIG. 4 is a cross sectional view of a portion of a self adjusting gasket mounted on the spigot end of the first pipe according to a third embodiment of the present disclosure;

FIG. 5A is a cross-sectional view of a portion of a fourth embodiment of a self adjusting gasket according to the present disclosure;

FIG. 5B is a cross sectional view of the self adjusting gasket of FIG. 5A compressed along the interface between the spigot end of a first pipe and the bell end of a second pipe;

FIG. 6 is a cross-sectional view of a portion of another embodiment of a self adjusting gasket according to the present disclosure;

FIG. 7 is an enlarged cross-sectional view of a portion of the third embodiment of the self adjusting gasket of FIG. 4 according to the present disclosure; and

FIG. 8 is an enlarged cross-sectional view of a portion of the first embodiment of the self adjusting gasket of FIGS. 1 and 2 according to the present disclosure.

### DETAILED DESCRIPTION

It is to be understood that this detailed description and the figures are for purposes of illustrating exemplary embodiments only and are not intended to be limiting. Additionally, it will be appreciated that the drawings are not to scale and that portions of certain elements may be exaggerated for the purpose of clarity and ease of illustration.

The self adjusting gasket of the present disclosure is provided to mitigate deficiencies in the sealing and coupling of circular and especially non-circular piping systems utilizing a bell and spigot typed joint with a flexible gasket as the primary sealing element. Joint seals of bell and spigot type pipe systems are effective when, under compression, a gasket positioned between a surface of a spigot end and a surface of a bell end prevents leakage about the entire perimeter of the pipe joint. However, seal failures occur when the gasket is unable to seal the joint, for example, due to tolerances about angled or cornered edges, perimeter gaps, pipe installation misalignment or differential loading.

In accordance with the present disclosure, a self adjusting gasket has been developed to facilitate effective sealing in a piping system where a flexible, leak resistant joint is required. The self adjusting gasket finds particular application where coupling installation is subject to significant tolerance issues such as with large concrete piping systems having a non-circular cross section. In many of these instances, pipe installations require the use of cranes or other automatic lifting methods to properly position and align each pipe section. Variations in the alignment of such large heavy pipe sections necessitated the development of a more effective self adjusting gasket, as disclosed herein.

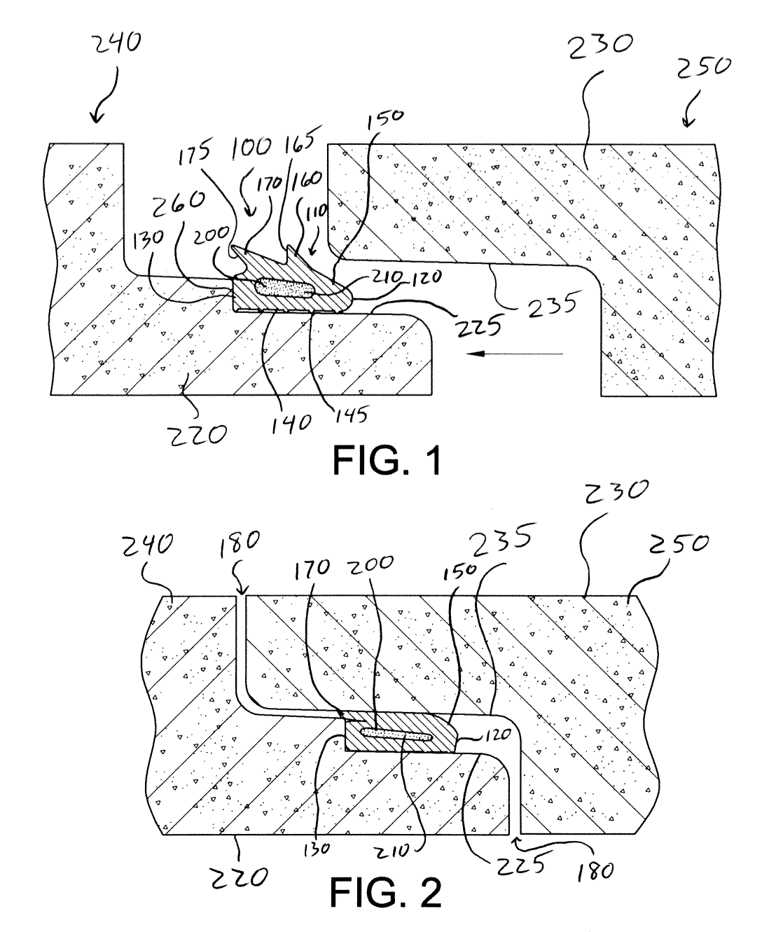

As illustrated in FIGS. 1, 2 and 8, a self adjusting gasket 100 includes a wedge shaped body 110 made of a generally compressible, leak proof materials such as rubber, EPDM, nitrile, neoprene, silicone, synthetic fluoropolymer, urethane, thermoplastic vulcanizates (TPVs) or other combinations of elastomeric type materials. The wedge shaped body 110 can be continuously extruded and then cut to a predetermined length relative to a perimeter of an associated spigot end 220 of a first pipe 240 to be coupled to an associated bell end 230 of a second pipe 250. A first end of the gasket body is then joined to a second end thereof by conventional means (such as splicing and vulcanizing) to form a continuous gasket as described below.

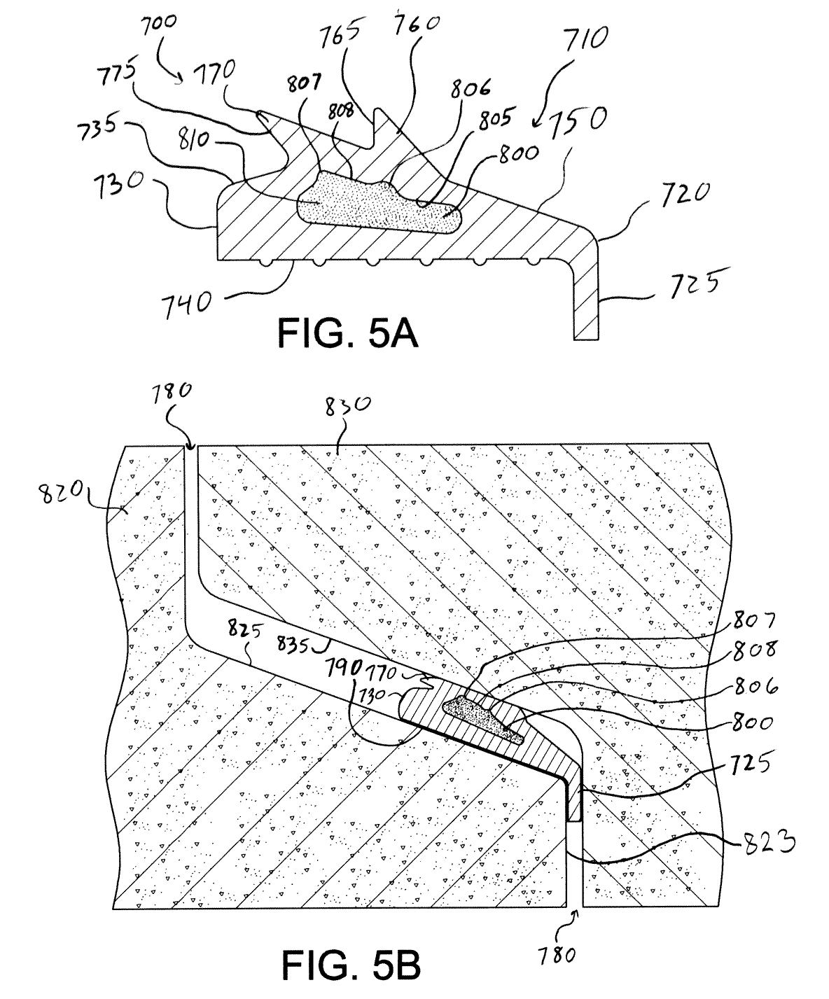

The wedge shaped body 110 includes a profile having a tapered front portion 120, a planar rear portion 130, a first contact surface 140, and an inclined second contact surface 150. The planar rear portion 130 is an abutment surface that can be oriented generally normal to the first contact surface 140. In one embodiment, the first contact surface 140 includes a plurality of compression ribs 145 for an improved grip to an associated pipe surface. Additionally, the first contact surface 140 can be mounted to the associated pipe surface with an adhesive (see FIG. 5B). The tapered front portion 120 can include various geometric shapes such as a pointed tip, a rounded or bullnose tip or a positioning flange extending therefrom.

The wedge shaped body 110 includes at least one protrusion or resilient sealing member such as a fin. In this illustrated embodiment, a first fin 160 extends from the inclined second contact surface 150 and includes a trailing edge 165 oriented generally normal to the first contact surface 140. The first fin 160 extends outwardly from the inclined second contact surface 150. A second fin 170 extends from the wedge shaped body 110 and is spaced from the first fin 160 such that the second fin 170 is oriented at an acute angle in relation to the first fin 160. The second fin 170 extends from the trailing edge 165 of the first fin 160 and includes a planar trailing surface 175 connected to an angled end surface 135 that extends from the planar rear portion 130.

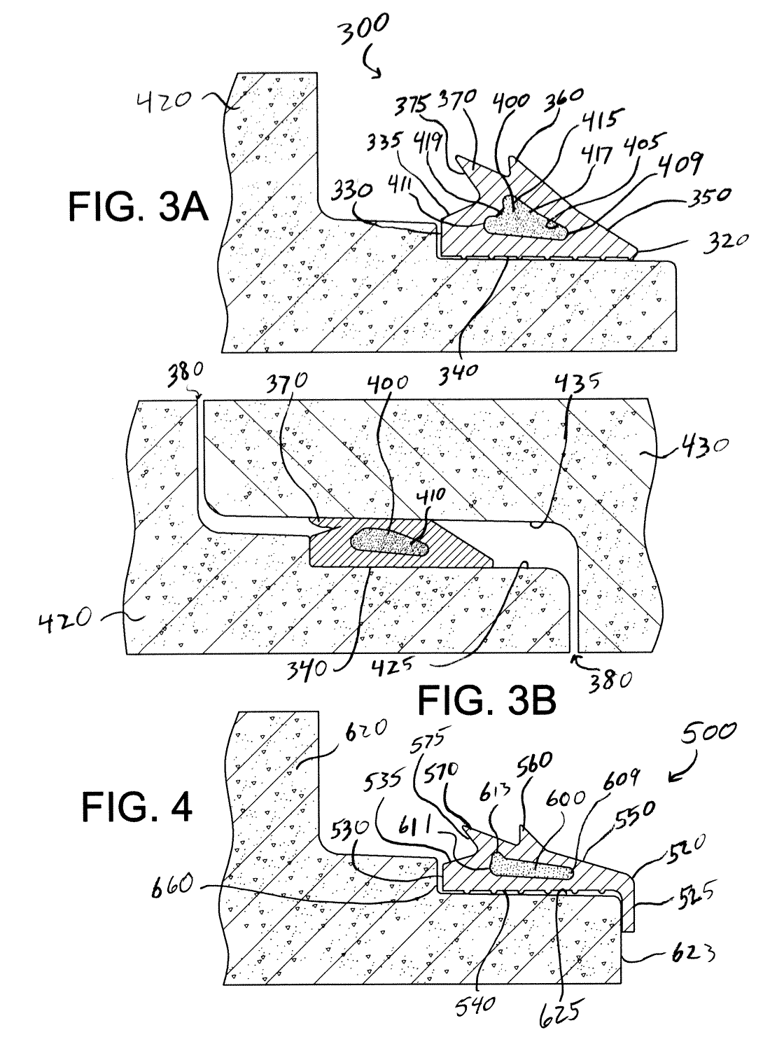

Another way of looking at the gasket body 110 would be that the second contact surface 150 continues after the first fin 160 and that the second fin 170 begins at a vertical line (not shown) extending upwardly from the intersection of the planar trailing surface 175 with the angled end surface 135. In one embodiment, the second fin 170 extends past the planar rear portion 130 such that the planar trailing surface 175 has a greater length than the planar end surface 135. (see FIGS. 1, 2 and 8) In other embodiments, a planar rear portion 330, 530, 730, 930 of a gasket extends past a second fin 370, 570, 770, 970 such that a planar end surface 335, 535, 735, 935 has a greater length than a planar trailing surface 375, 575, 775, 975. (see FIGS. 3-7)

The self adjusting gasket 100 also includes a generally continuous annular cavity 200 located in the wedge shaped body 110. A fluid 210 is disposed in the cavity 200 wherein the fluid 210 can be a gel type material. The fluid 210 can be a substantially incompressible fluid or gel material that is ideally stable in that it does not freeze or expand thermally under normal environmental conditions which are expected to be encountered in the field. Further disclosure concerning the fluid can be found in application Ser. No. 12/637,433 which is incorporated by reference hereinto in its entirety. Fluid 210 is injected within the annular cavity 200 through an injection port (not shown) and the injection port is then sealed. The cavity 200 is configured to accept and hold the fluid 210 when the gasket 100 is in both an uncompressed condition (see FIG. 1) and in a compressed condition at the interface 180 between a spigot surface 225 of the spigot end 220 of a first pipe 240 and a bell surface 235 of the bell end 230 of a second pipe 250. (see FIG. 2)

Notably, the shape of the cavity 200 profile is not symmetrical. In one embodiment, the profile of the cavity 200 is non-symmetrical relative to the first contact surface 140 in the uncompressed condition. The profile of the cavity 200 can also be non-symmetrical relative to the surface 225 of the spigot end 220 of the first pipe 240 in the uncompressed condition. The asymmetry of the profile of the cavity 200 can be relative to the geometric shape and tolerance of the spigot surface 225 and the bell surface 235 along a portion of the perimeter of the coupled pipe sections. Additionally, various asymmetric shapes of the cavity 200 relative to the orientations of the planar rear portion 130, first fin 160 and second fin 170 are contemplated to efficiently distribute the fluid 210 within the cavity 200 to sufficiently balance the pressure along the interface 180 and create a secure seal.

As illustrated in FIGS. 1 and 8, the cavity 200 generally includes an elongated profile having a first end 209 positioned towards the tapered front portion 120 and a second end 211 positioned towards the planar rear portion 130 such that the first end 209 is positioned in front of the first fin 160 and the second end 211 is positioned beneath the second fin 170. The second end 211 of the continuous annular cavity has a larger dimension than the first end 209. The self adjusting gasket 100 is a dynamic assembly to accommodate movement of the interface 180 which may be caused internally by effluents, externally by water table pressure or by movement of a backfill outside the pipe (if the pipe system is buried underground).

With reference to FIG. 1, the self adjusting gasket 100 is mounted on the surface 225 of the spigot end 220 of the first pipe 240. The bell end 230 of the second pipe 250 is positioned in spaced relation to the spigot end 220. The first gasket 100 includes the annular cavity 200 having a generally asymmetrical profile relative to the first contact surface 140 in an uncompressed condition. The first contact surface 140 and the spaced compression ribs 145 are mounted to the surface 225 of the spigot end 220. Optionally, the gasket can be secured in place with adhesive (see FIG. 5B). The planar rear portion 130 continuously abuts a step 260 at the spigot end 220 of the first pipe 240. The step 260 and configuration of the wedge shaped body 110 are adapted to hold the gasket 100 in place while the spigot end 220 is coupled to the bell end 230. In this embodiment, the second fin 170 extends past the planar rear portion 130 such that the planar trailing surface 175 has a greater length than the planar end surface 135. This configuration allows for more lateral shift of the gasket mass and can be used with smaller dimensioned pipe systems where the compressive forces acting on the gasket 100 are somewhat reduced.

With reference to FIG. 2, the self adjusting gasket 100 is positioned along the interface 180 formed between the spigot end 220 of the first pipe 240 and the bell end 230 of the second pipe 250 of FIG. 1. As the bell end 230 is introduced to the spigot end 220, the tapered front portion 120 having a rounded tip and the inclined second surface 150 of the wedge shaped body 110 are initially compressed between the spigot surface 225 and the bell surface 235. The planar rear portion 130 acts as a pressure point to aid in the distribution of the fluid 210 as the first fin 160 engages the bell surface 235. The pressure exerted herein compresses the sealing protrusion or first fin 160 and forces the fluid 210 to distribute within the annular cavity 200 to areas with less pressure applied on the wedge shaped body 110. As the bell end 230 comes to rest against the spigot end 220, the second fin 170 is also compressed and the fluid 210 within the cavity 200 is sufficiently distributed from areas having higher compressive forces to areas having lower compressive forces along the perimeter of the interface 180. The distribution of fluid balances the pressure exerted from the gasket 100 along the interface 180 against both the spigot surface 225 and bell surface 235. The asymmetric shape of the cavity 200 allows for a gradual buildup of compression forces to sufficiently distribute the fluid 210 from narrow, high pressure, high compression areas to wide, low pressure, low compression areas along the interface 180 as the bell surface 235 is drawn to the spigot surface 225.

The second fin 170 and planar rear portion 130 of the compressed gasket 100 functions as a hydraulic seal that is energized by the compressing forces of the first pipe 240 and second pipe 250 and by hydrostatic pressure from the environment outside the pipe. In FIG. 2, the second fin 170 extends past the planar rear portion 130 such that the second fin 170 assists in a pressure increase or “kick up” for the activation of the hydraulic seal. The geometric shape of the first fin 160 and the second fin 170 include generally planar sides having sufficient stiffness in the uncompressed condition to allow for a controlled deflection of the gasket 100 into the compressed orientation illustrated by FIG. 2. Additionally, the orientation and location of the planar rear portion 130, the first fin 160 and the second fin 170 relative to the shape of the cavity 200 offers sufficient stiffness to enhance fluid 210 distribution for the necessary sealing pressure in off-center alignment and maximum deflected or gapped areas along the interface 180. The cavity 200 can be non-symmetrical relative to the interface 180 along the perimeter of the coupled pipe sections in the compressed condition. However, the cavity 200 and fluid 210 may have various cross sectional profiles along the interface 180 in a compressed orientation due to the changes in the width of the interface 180 and or changing geometric shape of the surfaces 225, 235 along the interface 180.

In another embodiment of the present disclosure, as illustrated in FIG. 3A, the planar rear portion 330 of gasket 300 extends past the second fin 370 such that the planar end surface 335 has a greater length than the planar trailing surface 375. This configuration is suitable for pipe systems having deeper joints where it is preferable to keep the gasket material centered or local within the length of a first contact surface 340. A tapered front portion 320 includes a geometric shape having a generally pointed tip. Additionally, an annular cavity 400, holding a fluid 410, includes an asymmetrical profile having an elongated configuration with a continuous groove 415 along an interior surface 405 of the cavity 400. The groove 415 has a wedge shaped front portion 417 that mimics the configuration of a first fin 360 and an inclined second surface 350. A concave rear portion 419 extends between the groove 415 and a second end 411 that is opposite a slender first end 409.

FIG. 3B shows the gasket 300 of FIG. 3A in the compressed condition between a spigot end 420 and a bell end 430 of a pair of pipes. The compressed second fin 370 remains local within the footprint of the first contact surface 340 and the cavity 400 remains asymmetric relative to the first contact surface 340 in the compressed orientation but can have different elongated profiles along the perimeter in the compressed orientation. The fluid 410 is distributed throughout the annular cavity 400 to seal an interface 380 of the joint.

FIGS. 4 and 7 illustrate still another embodiment of the present disclosure wherein a gasket 500 includes a tapered front portion 520 with a positioning flange or locator flap 525. The positioning flange 525 extends from the tapered front portion 520 to engage an edge 623 of a spigot end 620 of a pipe. As shown in FIG. 4, the edge 623 of the spigot end 620 is oriented generally normal to a spigot surface 625 such that a first contact surface 540 of gasket 500 conforms to the geometry therein to provide a sufficient pressure point to maintain the position of the gasket 500 during pipe coupling. Additionally, the planar rear portion 530 of gasket 500 extends past the second fin 570 such that planar end surface 535 has a greater length than planar trailing surface 575. This configuration allows the second fin 570 to remain within the footprint of the first contact surface 540 when compressed within a pipe joint.

A cavity 600 of the gasket 500 of FIGS. 4 and 7 includes an elongated profile having a first end 609 positioned towards the tapered front portion 520 and a second end 611 positioned towards planar rear portion 530 such that the first end 609 is positioned in front of first fin 560 and the second end 611 is positioned beneath second fin 570. The second end 611 of the continuous annular cavity 600 is a slightly larger dimension than the first end 609. In this embodiment, cavity 600 is asymmetrical relative to the first contact surface 540 and includes a groove 613 positioned beneath second fin 570 that is adjacent to second end 609 of the elongated cavity 600. Additionally, planar rear portion 530 is mounted in close proximity to a step 660 of the spigot end 620.

FIGS. 5A and 5B illustrate another embodiment of the present disclosure wherein a gasket 700 is provided with a cavity 800 having an elongated asymmetrical profile relative to a first contact surface 740 and further including two spaced enlarged areas along an interior surface 805. A first enlarged area 806 is defined by a groove positioned beneath first fin 760 and a second enlarged area 807 is positioned beneath second fin 770. A space 808 between the first enlarge area 806 and the second enlarged area 807 includes a profile that mimics a portion of the geometry of the wedge shaped body 710 where the second fin 770 extends from trailing edge 765 of the first fin 760. This orientation is adapted to utilize a fluid 810 within the cavity 800 along with the wedge shaped body 710 to provide a dynamic seal at the interface 780 between a spigot end 820 with an angled spigot surface 825 and a bell end 830 with an angled bell surface 835. Notably, the spigot end 820 does not include a step in this embodiment as a positioning flange 725 depends from tapered front portion 720 of the gasket and continuously abuts edge 823 adjacent to the angled spigot surface 825 to hold the gasket 700 in place during coupling.

Adhesive 790 can be applied between first contact surface 740 and the angled spigot surface 825 to mount the gasket 700 in place on the spigot. Additionally, planar rear portion 730 of gasket 700 extends past second fin 770 such that planar end surface 735 has a greater length than planar trailing surface 775. This configuration allows the second fin 770 to remain within the footprint of the first contact surface 740 when compressed within the interface 780 of the pipe joint.

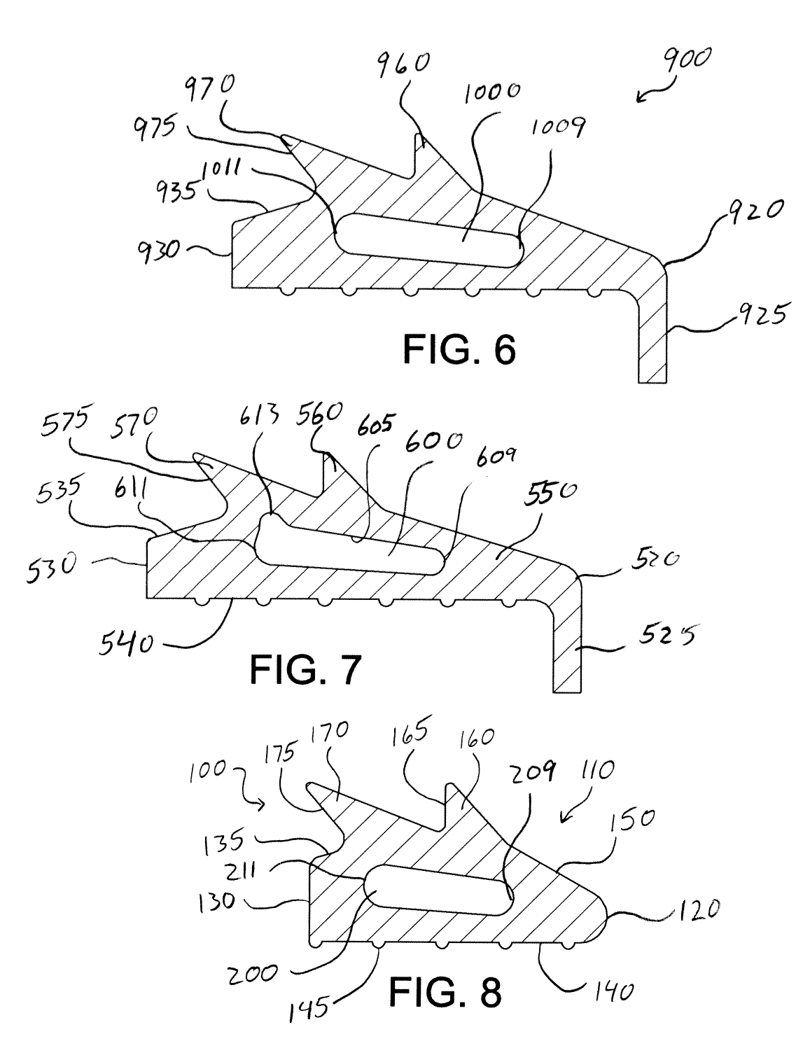

With reference now to the embodiment of FIG. 6, a gasket 900 can include a positioning flange 925 extending from a tapered front portion 920 and also having a continuous annular cavity with different asymmetric and elongated profiles. Gasket 900 includes a cavity 1000 having an elongated profile with a first end 1009 that is positioned in front of a first fin 960 and a second end 1011 that is positioned beneath second fin 970. The second end 1011 of the continuous annular cavity 1000 has a slightly larger dimension than the first end 1009. The elongated profile of cavity 1000 is similar to cavity 200 of gasket 100 in FIGS. 1, 2 and 8.

The following description of the gasket is with particular reference to FIGS. 1, 2 and 8. However, the following description can also be attributed to the embodiments illustrated in FIGS. 3-7. The cavity 200 is configured to allow the wedge shaped body 110 to conform to radial and linear portions of pipe surfaces 225, 235 due to stresses that are naturally occurring from the changes in joint geometry. More particularly, the changes in joint geometry occur along the perimeter of the pipe interface 180 such as along both the spigot end 220 of the first pipe 240 and the bell end 230 of the second pipe 250 where radial areas such as corners or angles transition to linear areas. More particularly, rectangular shaped pipes have circular/radial areas and extended portions of noncircular/linear areas. The changes in geometry, such as from radial to linear portions along the perimeter, cause an increased level of tension and compression forces acting on the gasket mounted therein as the spigot end 220 is coupled to the bell end 230 along these areas. Various forces are placed on the gasket 100 having a plurality of force vector profiles. These force vector profiles have different directions and magnitudes that are not easily identified by an associated installer at the site of the pipe section installation.

Notably, geometric changes along the perimeter of the pipe ends are addressed externally by the shape of the wedge shaped body 110 and internally by the dynamic fluid 210 within the asymmetrical cavity 200. More particularly, the first fin 160 and second fin 170 extend outwardly from the wedge shaped body 110 and utilize static compression and hydraulic pressure to create a leak resistant, and preferably leak proof seal against the surface 225 of the spigot end 220 simultaneously to the surface 235 of the bell end 230 when under compression. The configuration of the first fin 160 extends from the inclined second surface 150 to create a sealed effect with the surface 235 of the bell end 230 as a compression sealing function. The configuration of the second fin 170 provides a hydraulic pressure sealing function that extends from the wedge shaped body 110 to create a sealed effect with the surface 235 of the bell end 230. The first and second fins 160, 170 provide a dynamic seal along the interface 180 to prevent leakage of fluid from within the pipe system and to prevent leakage of fluid from the environment into the pipe system.

Additionally, the cavity 200 within the gasket 100 has a particular shape and location within the body 110 that is adapted to allow the fluid gel material 210 to continuously flow within the entire length of the cavity 200 throughout the gasket 100 to balance out the various tension and compression forces acting thereon. The cavity 200 is configured, with optional combinations of asymmetric shapes (such as grooves 415 and 613 or enlarged areas 806 and 807) along the interior surface 205, for distributing the fluid 210 in response to contact pressure that the gasket 100 exerts against the surfaces of the spigot end 220 and bell end 230. The ability of the fluid 210 to move within the cavity 200 in a predetermined orientation allows for the gasket 100 to effectively seal along the interface 180 in situations such as where geometric transitions occur along the perimeter, where deflection of the interface 180 occurs or where the irregular gapping between the surfaces 225, 235 is a problem. Typically, during coupling, when one side of the interface 180 is narrowed along the perimeter, the opposing side is widened. The dimensional tolerances may be slight along the pipe interface 180, however, even slight tolerances can compromise a seal and introduce a leak. The apparatus and method of the present disclosure allows for reducing mass of the self adjusting gasket 100 in tighter/narrower areas along the interface 180 and increasing the mass of the gasket 100 in open/wider areas along the perimeter in other areas.

More particularly, in many instances, the spigot surface 225 and the bell surface 235 include a slope or a taper relative to an exterior surface of the first and second pipes 240, 250. The slope of the pipe ends is designed to ease manufacturing concerns as well as allowing for simpler coupling to opposing pipe ends. In one embodiment, the shape of the cavity 200 is non-symmetric relative to the first contact surface 140 of the wedge shaped body 110. The shape of the cavity 200 can be sloped relative to the spigot surface 225 and bell surface 235 but will react to the slope or taper of the intersection to allow for lower compression forces and accomplish a homing or a self-adjusted fitting of the pipe ends during coupling. The shape of the cavity 200 is based upon directing the pressure to the area of the joint that is most in need.

During coupling, the tapered front portion 120 of the wedge shaped body 110 compresses first and the pressure exerted on the gasket 100 is directed to the planar rear portion 130. At this point, coupling pressure can be directed in multiple directions towards the planar rear portion 130 and can be manipulated by the asymmetrical shape of the cavity 200. The shape of the cavity 200 and location of the cavity 200 relative to the first fin 160 and second fin 170, depends at least on the annular space, slope, and tightness of the joint area. The shape of the cavity 200, having an elongated asymmetrical profile with a combination of grooves and enlarged areas, is designed to force the fluid 210 into the area of least resistance and provide a pressure balancing of the gasket 100 against the bell surface 235 and the spigot surface 225.

The gasket of the present disclosure simplifies pipe section installation where insertion force and point loading during coupling occurs at non-circular locations (such as oval, square, rectangular) along the perimeter of the pipe end. The asymmetrically shaped fluid filled cavity relative to the first and second fin orientations allow the gasket to yield and distribute the load throughout a broader pattern on the joint face.

The exemplary embodiments of the disclosure have been described herein. Obviously, modifications and alterations will occur to others upon reading and understanding the preceding detailed description. Combinations of the various features can be combined in each embodiment. It is intended that the instant disclosure be construed as including all such modifications and alterations insofar as they come within the scope of the appended claims or the equivalents thereof.

1. A self adjusting gasket to retard leakage at a joint between an associated first pipe and an associated second pipe comprising:
a wedge shaped body made of a generally compressible, leak proof material having a profile that includes:
a tapered front portion,
a planar rear portion,
a first contact surface,
an inclined second contact surface, including a first fin having a trailing edge oriented generally normal to the first contact surface and a second fin spaced from the first fin,
a generally continuous annular cavity located in the wedge shaped body wherein the cavity is not symmetrically shaped, and a fluid disposed in the cavity.

2. The self adjusting gasket in accordance with claim 1, wherein the annular cavity includes an elongated profile having a first end positioned in front of the first fin and a second end positioned beneath the second fin.

3. The self adjusting gasket in accordance with claim 2, wherein the second end of the continuous annular cavity is of a larger dimension than the first end.

4. The self adjusting gasket in accordance with claim 1, wherein the second fin is oriented at an acute angle in relation to the first fin.

5. The self adjusting gasket in accordance with claim 2 wherein the elongated profile includes at least one enlarged area in the cavity.

6. The self adjusting gasket in accordance with claim 5 wherein the elongated profile includes two spaced enlarged areas in the cavity.

7. The self adjusting gasket in accordance with claim 6, wherein a first enlarged area is located beneath the first fin and a second enlarged area is located beneath the second fin.

8. The self adjusting gasket in accordance with claim 1, wherein the fluid comprises a gel material.

9. The self adjusting gasket in accordance with claim 1, wherein the tapered front portion includes a rounded tip.

10. The self adjusting gasket in accordance with claim 1, further comprising a positioning flange extending from the tapered front portion.

11. The self adjusting gasket in accordance with claim 10, wherein the positioning flange depends from the tapered front portion.

12. The self adjusting gasket in accordance with claim 1, wherein the first contact surface includes a plurality of spaced compression ribs.

13. The self adjusting gasket in accordance with claim 1, wherein the second fin includes a planar trailing surface attached to a planar end surface that extends from the planar end portion.

14. A method for manufacturing a self adjusting gasket to retard leakage at a joint between an associated first pipe and an associated second pipe; the method comprising:
extruding a continuous wedge shaped body having a profile in accordance with claim 1;
cutting the wedge shaped body to a predetermined length relative to a shape of the associated joint between the first and second pipes;
attaching a first end of the gasket body to a second end to form a continuous gasket;
injecting fluid within the annular cavity through an injection port; and
sealing the injection port.

15. A method of preventing leakage at an interface of a spigot end of a first pipe and a bell end of a second pipe, the method comprising:
mounting a self adjustable gasket to the spigot end of the first pipe, the gasket having a wedge shaped profile with a continuous annular cavity having a generally asymmetrical profile relative to the interface, the cavity holding a fluid;
positioning the bell end of the second pipe on the spigot end of the first pipe along the interface;
compressing the gasket against the bell end of the second pipe; and
distributing the fluid within the annular cavity to balance a compressive force along the interface such that a continuous seal is established along the interface.

16. The method of claim 15, further comprising providing a sealing protrusion on the gasket and sealing with the protrusion against the bell end of the second pipe.

17. The method of claim 15, wherein the step of mounting includes applying a layer of adhesive.

18. The method of claim 15, further comprising reorienting the bell end of the second pipe on the spigot end of the first pipe along the interface.

19. A self adjusting gasket comprising:
a compressible wedge shaped body including:
a contact surface having a plurality of compression ribs;
an inclined surface extending from the contact surface at a tapered front portion, the inclined surface including at least one resilient sealing member extending away from the inclined surface;
an abutment surface located opposite the tapered front portion, said abutment surface being oriented generally normal to the contact surface; and
an annular cavity located within the gasket that encloses an amount of fluid, said annular cavity having an orientation that is generally asymmetrical relative to the contact surface.

20. The self adjusting gasket profile in accordance claim 19, wherein the generally asymmetrical profile of the annular cavity is elongated.

21. The self adjusting gasket profile in accordance with claim 19, wherein the annular cavity includes a profile having at least one groove along an interior surface of the cavity.
